(19) United States
(12) Patent Application Publication
(10) Pub. No.: US 2024/0054389 A1
(43) Pub. Date: Feb. 15, 2024

(54) HEADLESS USER INTERFACE ARCHITECTURE ASSOCIATED WITH AN APPLICATION

(71) Applicant: Capital One Services, LLC, McLean, VA (US)

(72) Inventors: Andrew RICCHUITI, Dallas, TX (US); James DUNLAP, The Colony, TX (US); Christopher BROWN, Dallas, TX (US)

(21) Appl. No.: 17/819,781

(22) Filed: Aug. 15, 2022

(51) Int. Cl. G06N 20/00

(52) U.S. Cl. CPC G06N 20/00

(57) ABSTRACT

In some implementations, a system may receive, from a user device, a request to access information associated with the application. The request may include user device data indicating characteristic(s) associated with a particular use of the user device. The system may provide the user device data as input to a machine learning model, which may be trained based on historical data associated with historical usage of the application by the user device and/or other user devices. The system may receive, as an output from the machine learning model, a target environment associated with the user device. The system may identify a target user interface (UI) associated with the information associated with the application. The target UI may correspond to the target environment. The system may transmit, to the user device, UI data corresponding to the target UI.

### BACKGROUND

A display of a user device may display a user interface (e.g., a graphical user interface). A user interface may permit interactions between a user of the user device and the user device. In some cases, the user may interact with the user interface to operate and/or control the user device to produce a desired result. For example, the user may interact with the user interface of the user device to cause the user device to perform an action. Additionally, the user interface may provide information to the user

### SUMMARY

Some implementations described herein relate to a system for a headless user interface architecture associated with an application. The system may include one or more memories and one or more processors communicatively coupled to the one or more memories. The one or more processors may be configured to receive, from a user device, a request to access information associated with the application. The request may include user device data indicating one or more characteristics associated with a particular use of the user device. The one or more processors may be configured to provide, as input to a machine learning model, the user device data. The machine learning model may be trained based on historical data associated with historical usage of the application by one or more of the user device or other user devices. The one or more processors may be configured to receive, as an output from the machine learning model, a target environment, of a plurality of target environments, associated with the user device. The one or more processors may be configured to identify a target user interface of a plurality of user interfaces associated with the information associated with the application. The target user interface may correspond to the target environment. The one or more processors may be configured to transmit, to the user device, user interface data corresponding to the target user interface.

Some implementations described herein relate to a method for a headless user interface architecture of an application. The method may include receiving, by a system having one or more processors and from a user device, user device data indicating one or more characteristics associated with a particular use of the user device. The method may include determining, by the system and based on the one or more characteristics, a target environment, of a plurality of target environments, associated with the particular use of the user device. The method may include identifying, by the system, a target user interface, of a plurality of target user interfaces associated with the application, wherein the target user interface may correspond to the target environment. The method may include transmitting, by the system and to the user device, user interface data indicating the target user interface.

Some implementations described herein relate to a user device. The user device may include one or more memories and one or more processors communicatively coupled to the one or more memories. The one or more processors may be configured to transmit, to a system, a request to access information associated with an application. The request may include user device data indicating one or more characteristics associated with the user device. The one or more characteristics may correspond to a target environment, of a plurality of target environments, associated with a particular use of the user device. The one or more processors may be configured to receive, from the system, a target user interface, of a plurality of target user interfaces associated with the application. The target user interface may correspond to the target environment. The one or more processors may be configured to displaying the target user interface on a display of the user device.

### BRIEF DESCRIPTION OF THE DRAWINGS

FIGS. 1A-1D are diagrams of an example associated with a headless user interface (UI) architecture associated with an application, in accordance with some embodiments of the present disclosure.

FIG. 2 is a diagram illustrating an example of training and using a machine learning model in connection with a headless UI architecture associated with an application, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of a device associated with a headless UI architecture associated with an application, in accordance with some embodiments of the present disclosure.

FIGS. 5 and 6 are flowcharts of example processes associated with a headless UI architecture associated with an application, in accordance with some embodiments of the present disclosure.

### DETAILED DESCRIPTION

The following detailed description of example implementations refers to the accompanying drawings. The same reference numbers in different drawings may identify the same or similar elements.

Different technologies may enable users to have different experiences with applications operating on user devices. For example, extended reality, such as virtual reality (VR), augmented reality (AR), and mixed reality, provide users with immersive experiences via a particular application. However, in many cases, the different technologies implement specific user interfaces (UIs). Additionally, a particular user device may only be configured to employ a specific technology (e.g., VR or AR). Accordingly, applications often have generated different versions of the application corresponding to different technologies. However, to generate, store, manage, and/or operate multiple versions of the same application utilizes an excess amount of computing, network, and/or storage resources. Accordingly, it is desirable for a system to enable a single version of an application via which different UIs may be launched, thereby conserving computing, network, and/or storage resources.

Some implementations described herein provide a system that may determine a target environment (e.g., a standard web view environment, a VR environment, an AR environment, or a voice-based environment) associated with a user device or use of an application on the user device based on one or more characteristics received from the user device. The system then may identify a target UI (e.g., a standard web view UI, a VR UI, an AR UI, or a voice-based UI) that corresponds to the target environment, and the system may transmit the target UI to the user device in connection with a use of the application. In this manner, the UI architecture of the application is not attached to a specific UI and/or environment. Such headless architecture enables the system to dynamically provide a particular UI to the user device based on certain characteristics. Accordingly, multiple versions of the application are not needed, thereby conserving computing, networking, and/or storage resources that would otherwise be necessary for the multiple versions. Additionally, when the characteristics change (e.g., the use of the user device changes), the system may efficiently utilize computing and networking resources to quickly change the UI provided to the user device.

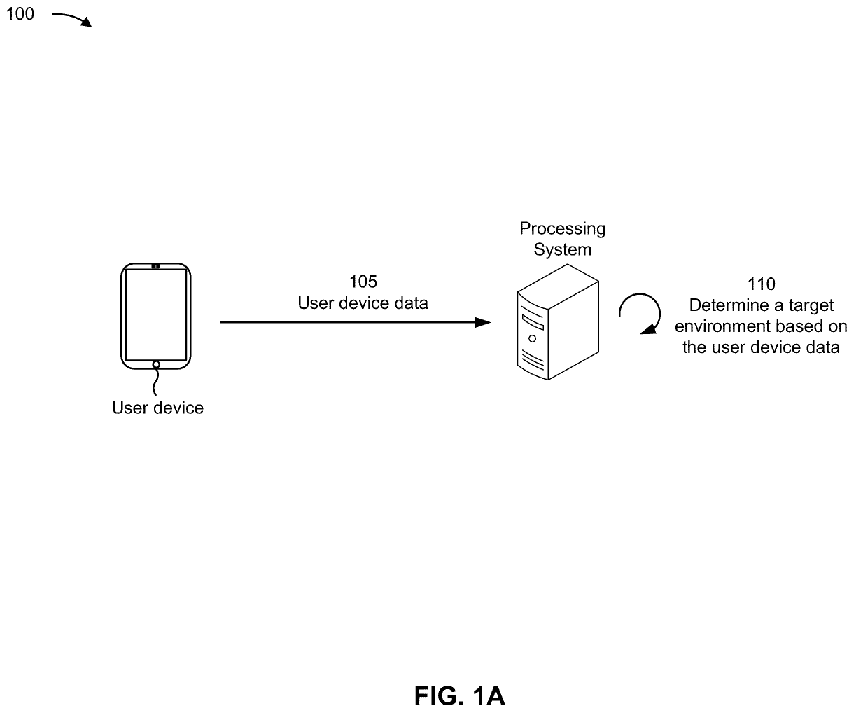

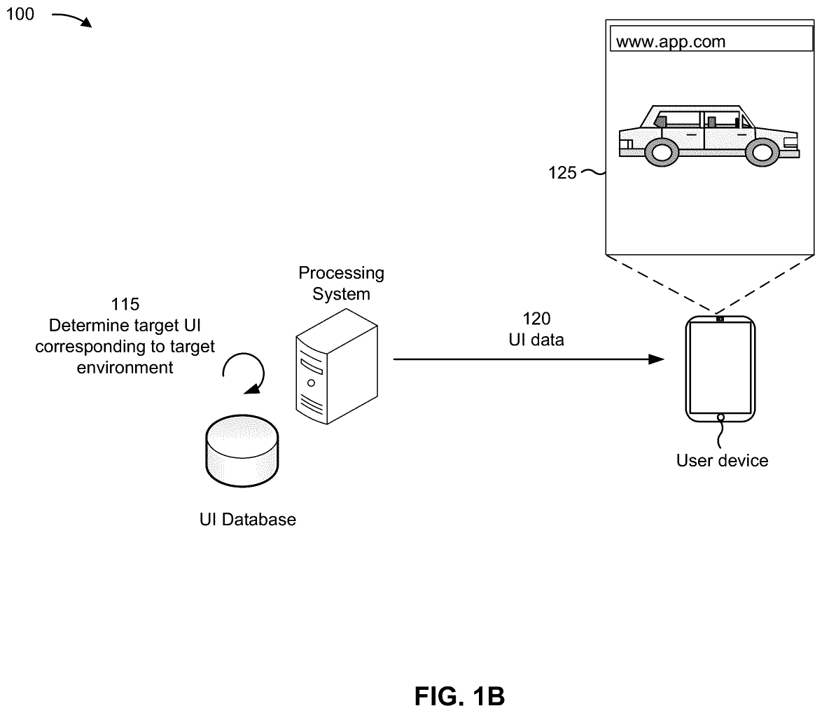

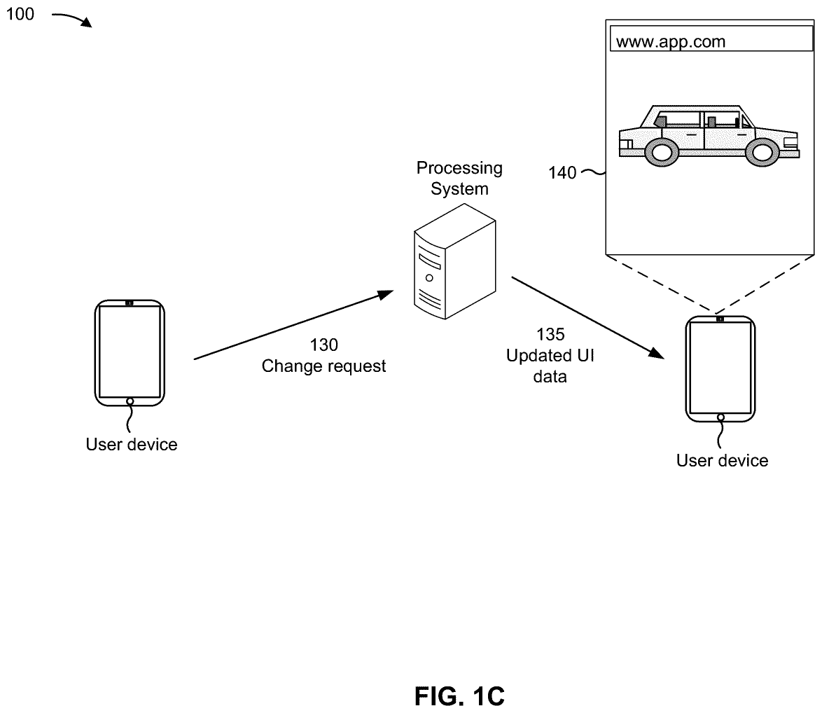

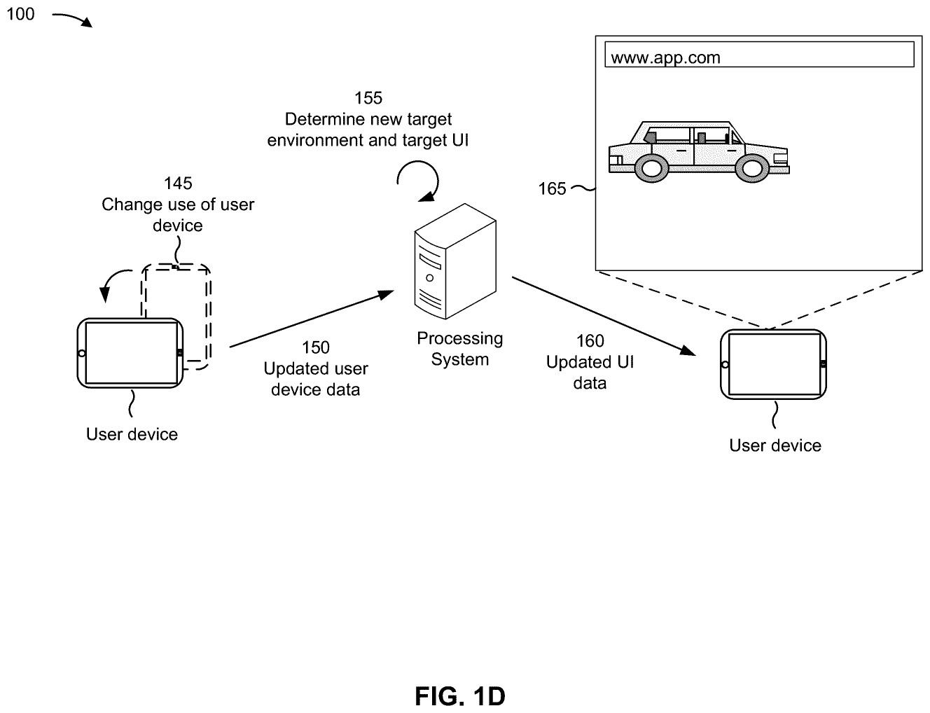

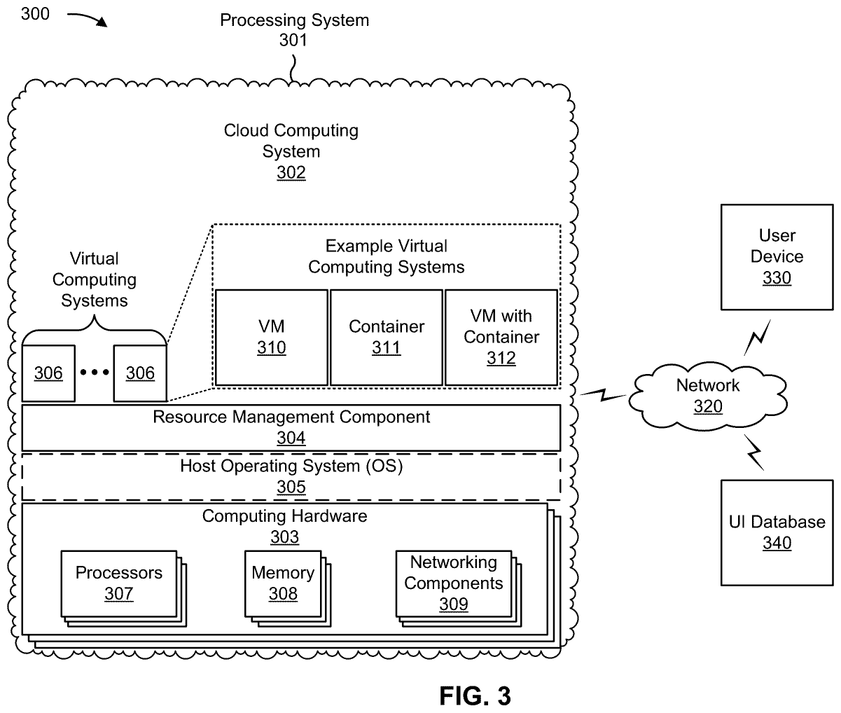

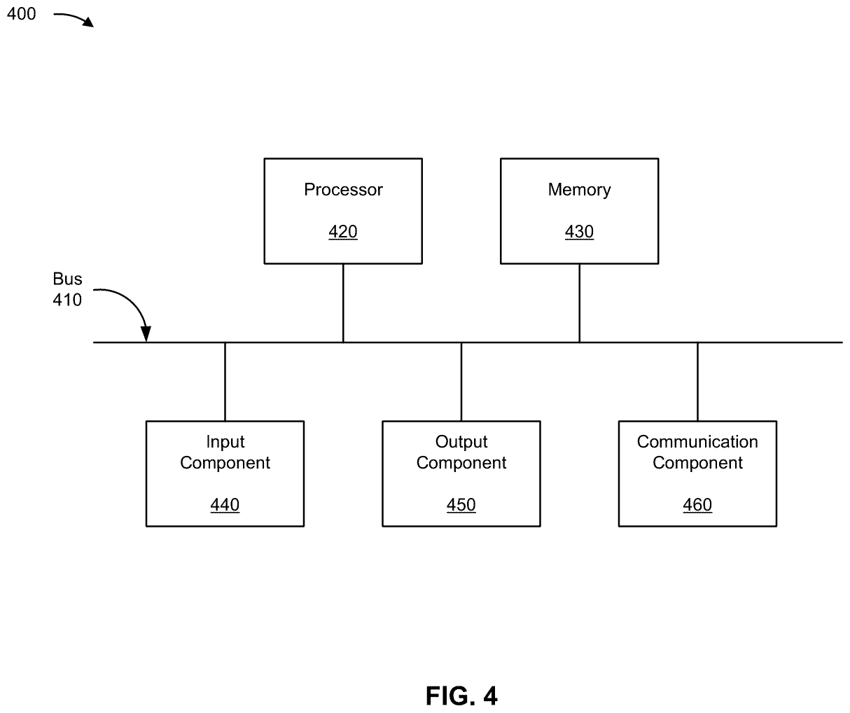

FIGS. 1A-1D are diagrams of an example 100 associated with a headless UI architecture associated with an application. As shown in FIGS. 1A-1D, example 100 includes a processing system, a user device, and a UI database. These devices are described in more detail in connection with FIGS. 3 and 4.

As shown in FIG. 1A, and by reference number 105, the user device may transmit, and the processing system may receive, user device data. For example, the user device may request to access information associated with an application (e.g., a web browser) installed on the user device (e.g., open and operate the application), where the request may include the user device data. The user device data may indicate one or more characteristics associated with the user device, a particular use of the user device, and/or a particular use of the application. In some implementations, the characteristic(s) may include a user device type, such as a mobile phone, a VR headset, or smart glasses. Additionally, or alternatively, the characteristic(s) may include a screen orientation (e.g., portrait or landscape) of the user device. Additionally, or alternatively, the characteristic(s) may include one or more global variables (e.g., webkit or navigation.xr) associated with a standard web view (e.g., for a web browser), a VR environment, and/or an AR environment.

As shown by reference number 110, the processing system may determine a target environment associated with the user device based on the user device data. A target environment refers to an environment in which the application is to operate on the user device (e.g., a standard web view for a web browser, a VR environment, an AR environment, or a voice-based environment). For example, if a characteristic is that a user device type is a VR headset, then the processing system may determine the target environment to be a VR environment. As another example, if a characteristic is that the user device type is smart glasses, then the processing system may determine the target environment to be an AR environment. As another example, if a characteristic is a global variable associated with a standard web view (e.g., webkit), then the processing system may determine the target environment to be a standard web view environment.

In some scenarios, the processing system may rely on multiple characteristics to determine the target environment. For example, a characteristic may be a global variable associated with a VR environment and/or an AR environment (e.g., navigation.xr). If another characteristic is that a screen orientation of the user device is a landscape orientation, then the processing system may determine the target environment to be a VR environment. If another characteristic is that the screen orientation is a portrait orientation, then the processing system may determine the target environment to be an AR environment. The processing system may analyze the multiple characteristics based on a hierarchy or ranking of the characteristics. For example, the ranking may be the user device type first, the global variable second, and the screen orientation third. If the processing system is able to determine the target environment from the user device type (e.g., if the user device type is smart glasses), then the processing system does not need to analyze any other characteristics indicated in the user device data. However, if the user device type is associated with more than one target environment, such as with a mobile device, then the processing system may proceed to analyze the next ranked characteristic(s).

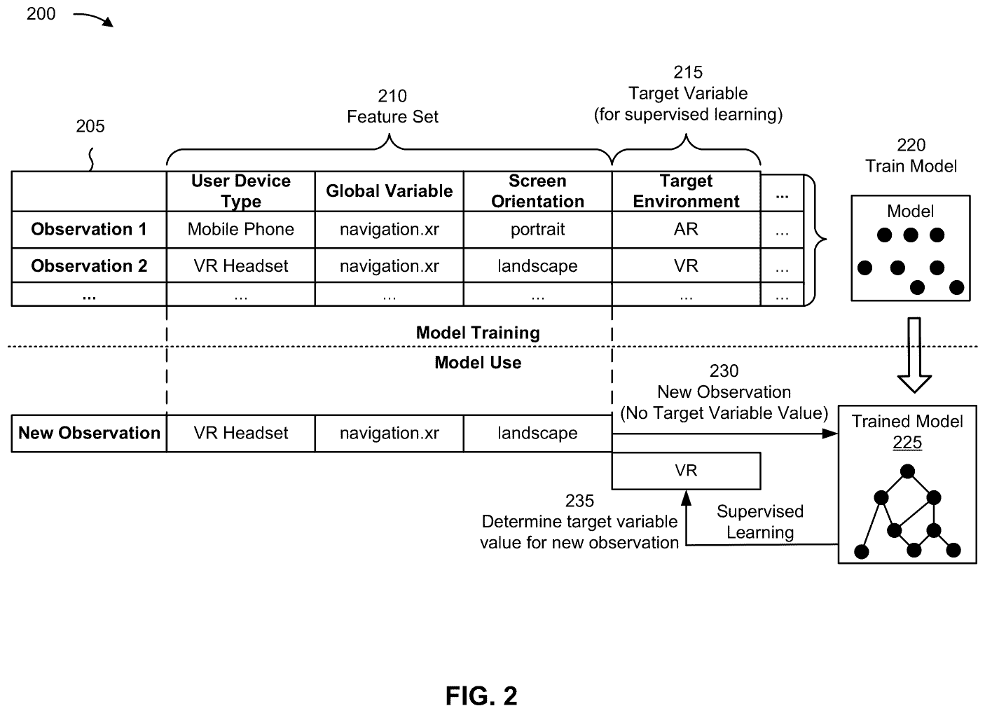

In some implementations, the processing system may use a machine learning model to determine the target environment, as described in more detail in connection with FIG. 2 below. For example, the processing system may provide the user device data as input to the machine learning model. The machine learning model may be trained based on historical data associated with historical usage of the application by the user device and/or other user devices (e.g., of the user and/or other users). The processing system then may receive the target environment as an output from the machine learning model.

As shown in FIG. 1B, and by reference number 115, the processing system may determine a target UI, from multiple possible UIs (e.g., a standard web view UI, a VR UI, or an AR UI) associated with the information associated with the application requested by the user device and corresponding to the target environment. For example, a target environment of a standard web view may have a corresponding target UI of a standard web view UI. A target environment of a VR environment may have a corresponding target UI of a VR UI. A target environment of an AR environment may have a corresponding target UI of an AR UI. The target UIs may be stored in a UI database. As shown by reference number 120, the processing system may transmit, and the user device may receive, UI data indicating the target UI. As shown by reference number 125, the user device may display the target UI on the display of the user device. Accordingly, the UI architecture of the application is headless (e.g., not attached to a specific UI and/or environment), which may allow the processing system to dynamically provide a particular UI to the user device based on certain characteristic(s), as described above.

In some scenarios, the user may desire to have a different UI than the one determined and transmitted by the processing system. As shown in FIG. 1C, and by reference number 130, the user device may transmit, and the processing system may receive, a change request to change the target UI to a different UI. For example, based on the characteristics received from the user device, the processing system may have determined and provided a VR UI to the user device, but the user may want a standard web view UI. As shown by reference number 135, based on the change request, the processing system may transmit, to the user device, updated UI data indicating the different UI corresponding to a different target environment. As shown by reference number 140, the user device may display the different UI on the display of the user device.

As shown in FIG. 1D, and by reference number 145, in some scenarios, the user may change the use of the user device (e.g., the target environment), thereby changing the user device data. As shown by reference number 150, the user device may transmit, and the processing system may receive, updated user device data indicating a change in the user device data (e.g., one or more characteristics). As shown by reference number 155, the processing system may determine an updated target environment associated with the change (e.g., from a VR environment to a standard web view environment). In some implementations, the processing system may be able to automatically detect when the change occurs. Alternatively, the processing system may periodically check for updated user device data. As further shown by reference number 155, the processing system may determine an updated target UI corresponding to the updated target environment. As shown by reference number 160, the processing system may transmit, and the user device may receive, the updated target UI. As shown by reference number 165, the user device may display the updated target UI on the display of the user device.

As described above, the processing system that may determine a target environment (e.g., a standard web view environment, a VR environment, an AR environment, or a voice-based environment) associated with a user device or use of an application on the user device based on one or more characteristics received from the user device. The processing system then may identify a target UI (e.g., a standard web view UI, a VR UI, an AR UI, or a voice-based UI) that corresponds to the target environment, and the system may transmit the target UI to the user device to be displayed with the use of the application. In this manner, the UI architecture of the application is headless (e.g., is not attached to a specific UI and/or environment), which enables the system to dynamically provide a particular UI to the user device based on certain characteristics. Accordingly, multiple versions of the application are not needed, thereby conserving computing, networking, and/or storage resources that would otherwise be necessary for the multiple versions. Additionally, when the characteristics change (e.g., the use of the user device changes), the system may efficiently utilize computing and networking resources to quickly change the UI provided to the user device.

As indicated above, FIGS. 1A-1D are provided as an example. Other examples may differ from what is described with regard to FIGS. 1A-1D.

FIG. 2 is a diagram illustrating an example 200 of training and using a machine learning model in connection with a headless UI architecture associated with an application. The machine learning model training and usage described herein may be performed using a machine learning system. The machine learning system may include or may be included in a computing device, a server, a cloud computing environment, or the like, such as the processing system 301 described in more detail elsewhere herein.

As shown by reference number 205, a machine learning model may be trained using a set of observations. The set of observations may be obtained from training data (e.g., historical data), such as data gathered during one or more processes described herein. In some implementations, the machine learning system may receive the set of observations (e.g., as input) from the processing system 301 and/or the user device 330, as described elsewhere herein.

As shown by reference number 210, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the processing system 201. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of a user device type, a second feature of a global variable, a third feature of a screen orientation, and so on. As shown, for a first observation, the first feature may have a value of “Mobile Phone”, the second feature may have a value of “navivation.xr”, the third feature may have a value of “portrait”, and so on. These features and feature values are provided as examples, and may differ in other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 200, the target variable is a target environment associated with the user device.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. After training, the machine learning system may store the machine learning model as a trained machine learning model 225 to be used to analyze new observations.

As an example, the machine learning system may obtain training data for the set of observations based on historical data associated with historical usage of the application by one or more of the user device or other user devices. The processing system 201 may provide, as inputs to the machine learning system, input data indicating user device types, global variables, and/or screen orientations.

As shown by reference number 230, the machine learning system may apply the trained machine learning model 225 to a new observation, such as by receiving a new observation and inputting the new observation to the trained machine learning model 225. As shown, the new observation may include a first feature of user device type, which has a value of “VR Headset,” a second feature of a global variable, which has a value of “navigation.xr,” a third feature of a screen orientation, which has a value of “landscape,” and so on, as an example. The machine learning system may apply the trained machine learning model 225 to the new observation to generate an output (e.g., a result). The type of output may depend on the type of machine learning model and/or the type of machine learning task being performed. For example, the output may include a target environment.

As an example, the trained machine learning model 225 may predict a value of “VR” for the target variable of target environment for the new observation, as shown by reference number 235. Based on this prediction, the machine learning system may perform a first automated action, and/or may cause a first automated action to be performed (e.g., by instructing another device to perform the automated action), among other examples. The first automated action may include, for example, identifying, obtaining, and/or transmitting, to a user device, a target UI corresponding to the target environment.

In some implementations, the trained machine learning model 225 may be re-trained using feedback information. For example, feedback may be provided to the machine learning model. The feedback may be associated with actions performed based on the recommendations provided by the trained machine learning model 225 and/or automated actions performed, or caused, by the trained machine learning model 225. In other words, the recommendations and/or actions output by the trained machine learning model 225 may be used as inputs to re-train the machine learning model (e.g., a feedback loop may be used to train and/or update the machine learning model). For example, the feedback information may be the change request received from the user device and/or if the change request is received within a time threshold (e.g., less than 30 seconds or 1 minute) of transmitting the target UI. Based on the change request, the processing system may determine that the incorrect target environment was determined, and may re-train the model using the different target environment corresponding to the different UI in the change request.

In this way, the machine learning system may apply a rigorous and automated process to determine target environments associated with user devices. The machine learning system enables recognition and/or identification of tens, hundreds, thousands, or millions of features and/or feature values for tens, hundreds, thousands, or millions of observations, thereby increasing accuracy and consistency and reducing delay associated with determining target environments associated with user devices relative to requiring computing resources to be allocated for tens, hundreds, or thousands of operators to manually determine target environments associated with user devices using the features or feature values.

As indicated above, FIG. 2 is provided as an example. Other examples may differ from what is described in connection with FIG. 2.

FIG. 3 is a diagram of an example environment 300 in which systems and/or methods described herein may be implemented. As shown in FIG. 3, environment 300 may include a processing system 301, which may include one or more elements of and/or may execute within a cloud computing system 302. The cloud computing system 302 may include one or more elements 303-312, as described in more detail below. As further shown in FIG. 3, environment 300 may include a network 320, a user device 330, and/or a UI database 340. Devices and/or elements of environment 300 may interconnect via wired connections and/or wireless connections.

The cloud computing system 302 may include computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from computing hardware 303 of the single computing device. In this way, computing hardware 303 can operate more efficiently, with lower power consumption, higher reliability, higher availability, higher utilization, greater flexibility, and lower cost than using separate computing devices.

Computing hardware 303 may include hardware and corresponding resources from one or more computing devices. For example, computing hardware 303 may include hardware from a single computing device (e.g., a single server) or from multiple computing devices (e.g., multiple servers), such as multiple computing devices in one or more data centers. As shown, computing hardware 303 may include one or more processors 307, one or more memories 308, and/or one or more networking components 309. Examples of a processor, a memory, and a networking component (e.g., a communication component) are described elsewhere herein.

The resource management component 304 may include a virtualization application (e.g., executing on hardware, such as computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 310. Additionally, or alternatively, the resource management component 304 may include a container manager, such as when the virtual computing systems 306 are containers 311. In some implementations, the resource management component 304 executes within and/or in coordination with a host operating system 305.

A virtual computing system 306 may include a virtual environment that enables cloud-based execution of operations and/or processes described herein using computing hardware 303. As shown, a virtual computing system 306 may include a virtual machine 310, a container 311, or a hybrid environment 312 that includes a virtual machine and a container, among other examples. A virtual computing system 306 may execute one or more applications using a file system that includes binary files, software libraries, and/or other resources required to execute applications on a guest operating system (e.g., within the virtual computing system 306) or the host operating system 305.

Although the processing system 301 may include one or more elements 303-312 of the cloud computing system 302, may execute within the cloud computing system 302, and/or may be hosted within the cloud computing system 302, in some implementations, the processing system 301 may not be cloud-based (e.g., may be implemented outside of a cloud computing system) or may be partially cloud-based. For example, the processing system 301 may include one or more devices that are not part of the cloud computing system 302, such as device 400 of FIG. 4, which may include a standalone server or another type of computing device. The processing system 301 may perform one or more operations and/or processes described in more detail elsewhere herein.

Network 320 may include one or more wired and/or wireless networks. For example, network 320 may include a cellular network, a public land mobile network (PLMN), a local area network (LAN), a wide area network (WAN), a private network, the Internet, and/or a combination of these or other types of networks. The network 320 enables communication among the devices of environment 300.

The user device 330 may include one or more devices capable of receiving, generating, storing, processing, and/or providing information associated with a headless UI architecture associated with an application, as described elsewhere herein. The user device 330 may include a communication device and/or a computing device. For example, the user device 330 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The UI database 340 may include one or more devices capable of receiving, generating, storing, processing, and/or providing information associated with a headless UI architecture associated with an application, as described elsewhere herein. The UI database 340 may include a communication device and/or a computing device. For example, the UI database 340 may include a data structure, a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device. As an example, the UI database 340 may store various target UIs corresponding to different target environments, as described elsewhere herein.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

FIG. 4 is a diagram of example components of a device 400 associated with a headless UI architecture associated with an application. Device 400 may correspond to the processing system 301, the user device 330, and/or the UI database 340. In some implementations, the processing system 301, the user device 330, and/or the UI database 340 may include one or more devices 400 and/or one or more components of device 400. As shown in FIG. 4, device 400 may include a bus 410, a processor 420, a memory 430, an input component 440, an output component 450, and a communication component 460.

Bus 410 may include one or more components that enable wired and/or wireless communication among the components of device 400. Bus 410 may couple together two or more components of FIG. 4, such as via operative coupling, communicative coupling, electronic coupling, and/or electric coupling. Processor 420 may include a central processing unit, a graphics processing unit, a microprocessor, a controller, a microcontroller, a digital signal processor, a field-programmable gate array, an application-specific integrated circuit, and/or another type of processing component. Processor 420 is implemented in hardware, firmware, or a combination of hardware and software. In some implementations, processor 420 may include one or more processors capable of being programmed to perform one or more operations or processes described elsewhere herein.

Memory 430 may include volatile and/or nonvolatile memory. For example, memory 430 may include random access memory (RAM), read only memory (ROM), a hard disk drive, and/or another type of memory (e.g., a flash memory, a magnetic memory, and/or an optical memory). Memory 430 may include internal memory (e.g., RAM, ROM, or a hard disk drive) and/or removable memory (e.g., removable via a universal serial bus connection). Memory 430 may be a non-transitory computer-readable medium. Memory 430 stores information, instructions, and/or software (e.g., one or more software applications) related to the operation of device 400. In some implementations, memory 430 may include one or more memories that are coupled to one or more processors (e.g., processor 420), such as via bus 410.

Input component 440 may enable device 400 to receive input, such as user input and/or sensed input. For example, input component 440 may include a touch screen, a keyboard, a keypad, a mouse, a button, a microphone, a switch, a sensor, a global positioning system sensor, an accelerometer, a gyroscope, and/or an actuator. Output component 450 enables device 400 to provide output, such as via a display, a speaker, and/or a light-emitting diode. Communication component 460 enables device 400 to communicate with other devices via a wired connection and/or a wireless connection. For example, communication component 460 may include a receiver, a transmitter, a transceiver, a modem, a network interface card, and/or an antenna.

Device 400 may perform one or more operations or processes described herein. For example, a non-transitory computer-readable medium (e.g., memory 430) may store a set of instructions (e.g., one or more instructions or code) for execution by processor 420. Processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry is used instead of or in combination with the instructions to perform one or more operations or processes described herein. Additionally, or alternatively, processor 420 may be configured to perform one or more operations or processes described herein. Thus, implementations described herein are not limited to any specific combination of hardware circuitry and software.

The number and arrangement of components shown in FIG. 4 are provided as an example. Device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

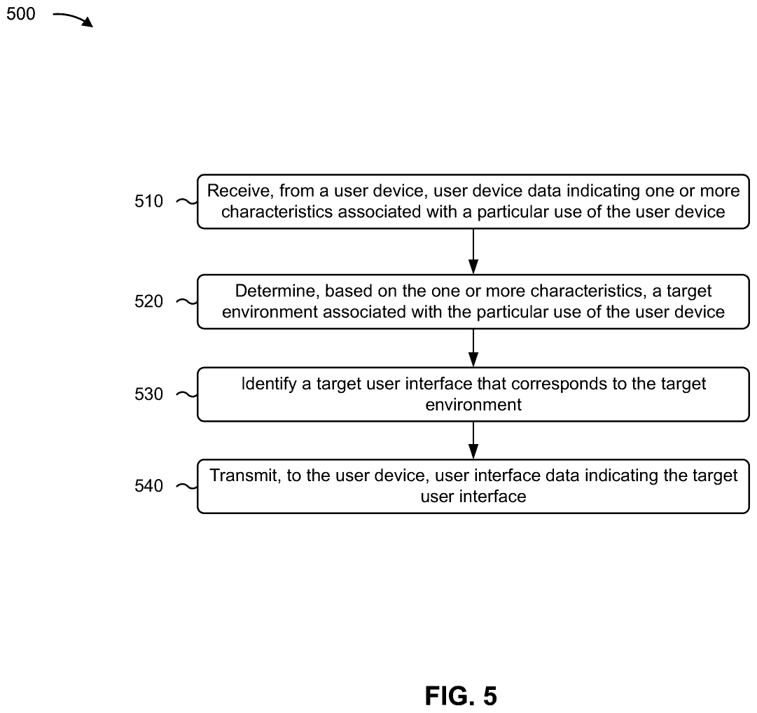

FIG. 5 is a flowchart of an example process 500 associated with a headless UI architecture associated with an application. In some implementations, one or more process blocks of FIG. 5 may be performed by the processing system 301. In some implementations, one or more process blocks of FIG. 5 may be performed by another device or a group of devices separate from or including the processing system 301, such as the user device 330. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include receiving, from a user device, user device data indicating one or more characteristics associated with a particular use of the user device (block 510). For example, the processing system 301 (e.g., using processor 420, memory 430, input component 440, and/or communication component 460) may receive, from a user device, user device data indicating one or more characteristics associated with a particular use of the user device, as described above in connection with reference number 105 of FIG. 1A. As an example, the user device may transmit, and the processing system may receive, user device data. For example, the user device may request to access information associated with an application (e.g., a web browser) installed on the user device (e.g., open and operate the application), where the request may include the user device data. The user device data may indicate one or more characteristics associated with the user device, a particular use of the user device, and/or a particular use of the application.

As further shown in FIG. 5, process 500 may include determining, based on the one or more characteristics, a target environment associated with the particular use of the user device (block 520). For example, the processing system 301 (e.g., using processor 420 and/or memory 430) may determine, based on the one or more characteristics, a target environment, of a plurality of target environments, associated with the particular use of the user device, as described above in connection with reference number 110 of FIG. 1A. As an example, the processing system may determine, based on the user device, a target environment associated with the user device (e.g., an environment in which the application is to operate on the user device, such as a standard web view for a web browser, a VR environment, an AR environment, or a voice-based environment).

As further shown in FIG. 5, process 500 may include identifying a target UI that corresponds to the target environment (block 530). For example, the processing system 301 (e.g., using processor 420 and/or memory 430) may identify a target UI, of a plurality of target UIs associated with the application, wherein the target UI corresponds to the target environment, as described above in connection with reference number 115 of FIG. 1B. As an example, the processing system may determine a target UI, from multiple possible UIs (e.g., a standard web view UI, a VR UI, or an AR UI) associated with the information associated with the application requested by the user device and corresponding to the target environment.

As further shown in FIG. 5, process 500 may include transmitting, to the user device, UI data indicating the target UI (block 540). For example, the processing system 301 (e.g., using processor 420, memory 430, and/or communication component 460) may transmit, to the user device, UI data indicating the target UI, as described above in connection with reference number 120 of FIG. 1B. As an example, the processing system may transmit, and the user device may receive, UI data indicating the target UI.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1D. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

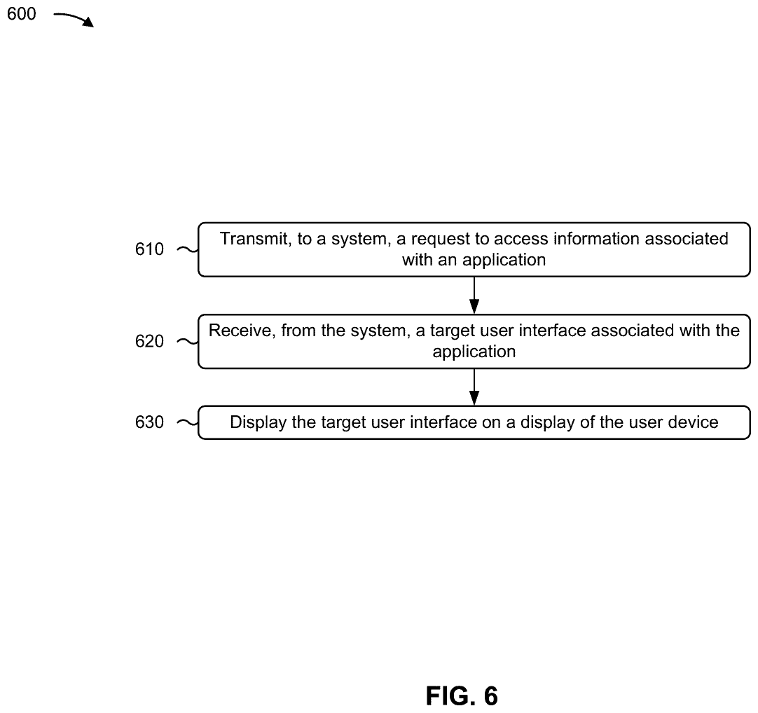

FIG. 6 is a flowchart of an example process 600 associated with a headless UI architecture associated with an application. In some implementations, one or more process blocks of FIG. 6 may be performed by the user device 330. In some implementations, one or more process blocks of FIG. 6 may be performed by another device or a group of devices separate from or including the user device 330, such as the processing system 301. Additionally, or alternatively, one or more process blocks of FIG. 6 may be performed by one or more components of the device 400, such as processor 420, memory 430, input component 440, output component 450, and/or communication component 460.

As shown in FIG. 6, process 600 may include transmitting, to a system, a request to access information associated with an application (block 610). For example, the user device 330 (e.g., using processor 420, memory 430, and/or communication component 460) may transmit, to a system, a request to access information associated with an application, wherein the request includes user device data indicating one or more characteristics associated with the user device, and wherein the one or more characteristics correspond to a target environment, of a plurality of target environments, associated with a particular use of the user device, as described above in connection with reference number 105 of FIG. 1A. As an example, the user device may transmit, and the processing system may receive, user device data. For example, the user device may request to access information associated with an application (e.g., a web browser) installed on the user device (e.g., open and operate the application), where the request may include the user device data. The user device data may indicate one or more characteristics associated with the user device, a particular use of the user device, and/or a particular use of the application.

As further shown in FIG. 6, process 600 may include receiving, from the system, a target UI associated with the application (block 620). For example, the user device 330 (e.g., using processor 420, memory 430, input component 440, and/or communication component 460) may receive, from the system, a target UI, of a plurality of target UIs associated with the application, wherein the target UI corresponds to the target environment, as described above in connection with reference number 120 of FIG. 1B. As an example, the processing system may transmit, and the user device may receive, UI data indicating the target UI.

As further shown in FIG. 6, process 600 may include displaying the target UI on a display of the user device (block 630). For example, the user device 330 (e.g., using processor 420, memory 430, and/or output component 450) may display the target UI on a display of the user device, as described above in connection with reference number 125 of FIG. 1B. As an example, the user device may display the target UI on the display of the user device.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel. The process 600 is an example of one process that may be performed by one or more devices described herein. These one or more devices may perform one or more other processes based on operations described herein, such as the operations described in connection with FIGS. 1A-1D. Moreover, while the process 600 has been described in relation to the devices and components of the preceding figures, the process 600 can be performed using alternative, additional, or fewer devices and/or components. Thus, the process 600 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for a headless user interface architecture associated with an application, the system comprising:
one or more memories; and
one or more processors, communicatively coupled to the one or more memories, configured to:
receive, from a user device, a request to access information associated with the application,
wherein the request includes user device data indicating one or more characteristics associated with a particular use of the user device;
provide, as input to a machine learning model, the user device data,
wherein the machine learning model is trained based on historical data associated with historical usage of the application by one or more of the user device or other user devices;
receive, as an output from the machine learning model, a target environment, of a plurality of target environments, associated with the user device;
identify a target user interface of a plurality of user interfaces associated with the information associated with the application,
wherein the target user interface corresponds to the target environment; and
transmit, to the user device, user interface data corresponding to the target user interface.

2. The system of claim 1, wherein the one or more processors are further configured to:
re-train the machine learning model based on feedback received from the user device,
wherein the feedback includes a change request for a different user interface, of the plurality of user interfaces.

3. The system of claim 1, wherein the one or more characteristics include a global variable associated with a standard web view.

4. The system of claim 1 wherein the target environment is a standard web view environment, and
wherein the target user interface is a standard web view user interface.

5. The system of claim 1, wherein the one or more characteristics include:
a global variable associated with one or more of a virtual reality environment or an augmented reality environment, and
a screen orientation associated with a display screen of the user device.

6. The system of claim 5, wherein the target environment is the virtual reality environment if the screen orientation is a landscape orientation, and
wherein the target user interface is a virtual reality user interface.

7. The system of claim 5, wherein the target environment is the augmented reality environment if the screen orientation is a portrait orientation, and
wherein the target user interface is an augmented reality user interface.

8. The system of claim 1, wherein the application is a web browser.

9. A method for a headless user interface architecture of an application, comprising:
receiving, by a system having one or more processors and from a user device, user device data indicating one or more characteristics associated with a particular use of the user device;
determining, by the system and based on the one or more characteristics, a target environment, of a plurality of target environments, associated with the particular use of the user device;
identifying, by the system, a target user interface, of a plurality of target user interfaces associated with the application,
wherein the target user interface corresponds to the target environment; and
transmitting, by the system and to the user device, user interface data indicating the target user interface.

10. The method of claim 9, further comprising:
receiving, from the user device, updated user device data indicating a change in the one or more characteristics associated with the particular use of the user device;
determining, based on the change in the one or more characteristics, an updated target environment of the plurality of target environments;
identifying an updated target user interface of the plurality of target user interfaces, corresponding to the updated target environment; and
transmitting, to the user device, the updated target user interface.

11. The method of claim 9, wherein the plurality of target environments include one or more of a standard web view environment, a virtual reality environment, an augmented reality environment, or a voice-based environment.

12. The method of claim 9, wherein the one or more characteristics include a global variable associated with a standard web view.

13. The method of claim 9, wherein the target environment is a standard web view environment, and
wherein the target user interface is a standard web view user interface.

14. The method of claim 9, wherein the one or more characteristics include:
a global variable associated with one or more of a virtual reality environment or an augmented reality environment, and
a screen orientation associated with a display screen of the user device.

15. The method of claim 14, wherein the target environment is the virtual reality environment if the screen orientation is a landscape orientation, and
wherein the target user interface is a virtual reality user interface.

16. The method of claim 14, wherein the target environment is the augmented reality environment if the screen orientation is a portrait orientation, and
wherein the target user interface is an augmented reality user interface.

17. A user device comprising:
one or more memories; and
one or more processors, communicatively coupled to the one or more memories, configured to:
transmit, to a system, a request to access information associated with an application,
wherein the request includes user device data indicating one or more characteristics associated with the user device, and
wherein the one or more characteristics correspond to a target environment, of a plurality of target environments, associated with a particular use of the user device;
receive, from the system, a target user interface, of a plurality of target user interfaces associated with the application,
wherein the target user interface corresponds to the target environment; and
displaying the target user interface on a display of the user device.

18. The user device of claim 17, wherein the one or more processors are further configured to:
transmit, to the system, updated user device data indicating a change in the one or more characteristics,
wherein the change in the one or more characteristics is associated with an updated target environment of the plurality of target environments;
receive, from the system, an updated target user interface corresponding to the updated target environment; and
display the updated target user interface on the display of the user device.

19. The user device of claim 17, wherein the one or more processors are further configured to:
transmit, to the system, a change request for a different user interface, of the plurality of target user interfaces, within a time threshold of transmitting the target user interface,
wherein the different user interface corresponds to a different target environment;
receive, from the system, the different user interface; and
display the different user interface on the display of the user device.

20. The user device of claim 17, wherein the plurality of target environments include one or more of a standard web view environment, a virtual reality environment, an augmented reality environment, or a voice-based environment.
